(19) United States
(12) Patent Application Publication
(10) Pub. No.: US 2023/0082158 A1
(43) Pub. Date: Mar. 16, 2023

(54) FREQUENCY TUNABLE DIELECTRIC APPARATUS APPLIED TO BUILDING COMPONENTS AND ARRANGEMENT METHOD THEREOF

(71) Applicant: EIKO TECHNO CORPORATION PTE. LTD., SINGAPORE (SG)

(72) Inventor: MING LU, NEW TAIPEI CITY (TW)

(21) Appl. No.: 17/931,694

(22) Filed: Sep. 13, 2022

Related U.S. Application Data
(60) Provisional application No. 63/261,138, filed on Sep. 13, 2021.

(51) Int. Cl. H01Q 15/00; H01Q 1/22

(52) U.S. Cl. CPC H01Q 15/002; H01Q 1/22

(57) ABSTRACT

A frequency tunable dielectric apparatus applied to building components is disclosed, which is used to increase the transmittance and the transmission bandwidth of signals. The dielectric apparatus includes a structural body, a frequency-tuning component, and a positioning component. The structural body is formed of a dielectric material with an equivalent dielectric constant value ranging from more than 1 to less than 200000. The structural body is coupled to the target component by the positioning component to form a composite structure. The minimum equivalent diameter of the dielectric structure corresponding to the composite structure on the projected area of the surface through which the RF signal passes on the surface of the target component is not less than one-eighth of the working wavelength. By changing the spacing, the dielectric apparatus may be used to tune the working frequency and enhance the transmittance and transmission bandwidth.

### CROSS-REFERENCE TO RELATED APPLICATION

This application claims priority from U.S. Provisional Patent Application No. 63/261,138, filed on Sep. 13, 2021, in the United States Patent and Trademark Office, the content of which is hereby incorporated by reference in its entirety for all purposes.

### BACKGROUND OF THE INVENTION

### 1. Field of the Invention

The present disclosure relates to a frequency tunable dielectric apparatus applied to building components and an arrangement method thereof. After the dielectric apparatus is coupled to the dielectric building components, a structurally adjustable composite structure is formed in the space covered by the RF (radio frequency) signal transmission path. By adjusting the structure of the dielectric apparatus, the user may tune the working frequency of the RF signal passing through the composite structure and increase the signal strength and transmission bandwidth of the working frequency.

### 2. Description of the Related Art

Not being limited by physical wirings, wireless RF communication technology has the advantages of providing wide-area services, multi-point real-time communication, and low system construction and maintenance costs, so wireless RF communication technology has become the mainstream technology used in the communication industry. Based on these facts, the communication industry has further adopted multi-band high-frequency electromagnetic waves for signal transmission to meet the market demand for huge amount and high speed of information transmission. With laboratory technology transformed into products and commercialization services by telecommunications and network service companies in various countries, it can be found that although excellent signal strength and high signal coverage performance can be measured in open outdoor environments, the signal strength and coverage tend to be weakened significantly from outdoors to indoors or in a partitioned indoor environment due to the use of high-frequency electromagnetic wave spectrum, which has a significant impact on the range of communication services and speed of data transmission. In view of this, after systematic measurements and analysis of the problem were carried out by various industrial, academic, and research institutions, it is shown that building materials and construction of building components have a critical impact on the quality of signal transmission owing to the frequency band used by the wireless RF signal being increased to high frequency spectrum. Among the various influencing parameters, the dielectric constant of the material has the greatest influence. Although dielectric material with low dielectric loss is used as building materials or for making building components, the reflection loss may still occur due to a mismatch between the dielectric constants of the material itself and the surroundings in a specific electromagnetic wave spectrum. Taking the measurement result on an uncoated glass window in the air using a 5.2 GHz RF signal as an example, a single-layer glass may cause the loss of signal strength of 2 to 4 dB. That is, approximately 50% of the energy of the electromagnetic wave may be converted into the reflection and absorption loss due to the shielding of the glass during the transmission. Next, for critical parameters that affect performance as the structure of the building or building components, also taking the measurement result on an uncoated glass window in the air using a 5.2 GHz RF signal as an example, the test was conducted using a double-layer window made of the same glass as the previous example. The result shows that the loss of signal strength of 9 to 11 dB may be caused, which means that about 90% of the energy would be reflected and absorbed due to the influence of glass and structure. Based on the aforementioned examples, it can be seen that glass materials and structures through which the electromagnetic waves of RF communication pass have a significant impact on the signal strength degradation during the transmission. The same problem may also be widely found in buildings with walls or partitions made of dielectric materials such as glass, gypsum, brick, cement, wooden board, plastic, and composite plywood. In addition to optimizing building components with materials and structures to enable new or renovated buildings to be better penetrated by RF signals at specific frequencies, how to use external apparatuses together with existing buildings or building components to improve the penetration performance of RF signals at specific frequencies is also a critical issue remaining to be solved in the current communication and construction industries.

To solve the aforementioned problem of signal attenuation caused by the materials and structures used in building components made of dielectric materials, several examples have been studied and may be categorized into several solutions according to different operating mechanisms, including inner antennas, inner and outer antennas with lead wires, dielectric antennas, periodic conductive structure, and the like. The solutions with an internal antenna as well as an internal and external antenna with lead wires have been widely used in vehicle communication and building environments. For such solutions, signals are received through an antenna, the received signals are amplified or not according to the system design requirements, and the processed signals are then sent out through a lead wire or an antenna. For other solutions, a surface of a dielectric object is used as an antenna substrate, and a dielectric antenna for transceiving signals is prepared through a patterned conductive layer. Actual examples can be found in the patent applications, such as U.S. Pat. Nos. 3,728,732, 4,849766, 5,083,133, 5,821,904, 5,867,129, 6,121,934, 6,239,758, 6,661,386, 7,091,915, 8,009,107, 9,350,071, EP1343221, EP2581983, CN104685578B, and CN105075008. In the solution of a periodic metal structure, the periodic metal structure is prepared on dielectrics. By adjusting the size of the metal structure, the overall structure to an electromagnetic wave at a specific wavelength generates a selective transmittance. This periodic metal structure is also called a frequency selective surface. Related actual examples can be found in the patent applications, such as JP2004053466, JP2011254482, U.S. Pat. No. 4,125,841, 6,730,389, 10,741,928, CN1561559, and CN104269586. However, all the solutions as mentioned above require a conductive structure for transceiving electromagnetic signals or filtering. In addition, due to the limitations of dielectric constant values, sizes, and patterned structures of the used material, it is not possible for users to adjust the electromagnetic wave spectrum passing through the building components according to different usage requirements.

### SUMMARY OF THE INVENTION

The present disclosure provides a dielectric apparatus and an arrangement method thereof, which may be used to tune working frequency, enhance the electromagnetic wave transmittance of building components made of existing dielectric materials, and increase the RF communication bandwidth. Since there is no need to make a patterned conductive layer, and no power and signal contacts are required, it has the advantages of easy production, low cost, and simple installation. In addition, since the frequency of electromagnetic waves can be adjusted by apparatuses, not only may the function of adjusting the working frequency be provided, but also a greater application latitude may be obtained in terms of dielectric constant, physical size, and structure of the target component under a specific targeted working frequency.

According to one embodiment of the present disclosure, a frequency tunable dielectric apparatus applied to building components is provided, which may increase the transmittance of RF signals and widen the transmission bandwidth of RF signals, and may be used to tune the working frequency. The dielectric apparatus includes a structural body, a frequency-tuning component, and a positioning component; the structural body is formed of at least one dielectric material; the positioning component is configured to couple the structural body and the frequency-tuning component to a target component (building components); the frequency-tuning component achieves the purpose of tuning the frequency by adjusting the spacing between each of the dielectric material layers in the structural body, or the spacing between the dielectric material layers in the structural body and the target component. The dielectric constant value of the dielectric material forming the structural body ranges from greater than 1 to not greater than 200000; the dielectric apparatus is coupled to the building components to form a composite structure; the composite structure allows the RF signal corresponding to the working frequency to pass through by adjusting the frequency-tuning component, thus reducing the reflection loss; the minimum equivalent diameter of the dielectric structure corresponding to the composite structure on the projected area of the surface through which the RF signal passes on the surface of the target component is not less than one-eighth of the working wavelength corresponding to the working frequency.

Preferably, the dielectric apparatus may be divided into different blocks according to application requirements to correspond to different working frequencies; the dielectric material forming the structural body of each block may be a dielectric material using the same or different dielectric constant values; through the different design structures of the frequency-tuning component and each block, the admittance value of each block may be adjusted to meet the requirements of the minimum reflectance of the corresponding working frequency; the dielectric constant value of the dielectric material forming the structural body ranges from greater than 1 to not greater than 200000; the minimum equivalent diameter of the dielectric structure corresponding to the composite structure of each block on the projected area of the surface through which the RF signal passes on the surface of the target component is not less than one-eighth of the working wavelength corresponding to the working frequency.

Preferably, the dielectric material of the structural body of each block may further include a composite structure layer formed of second or more dielectric materials, the dielectric constant value of which ranges from greater than 1 to not greater than 200000.

Preferably, the structural body may further include a plurality of dielectric material layer with more than one layer, each of which has a dielectric constant value in the range from greater than 1 to not greater than 200000.

Preferably, for the structural body with the plurality of dielectric material layers, each of the dielectric material layers may have an independent frequency control component connected thereto, controlling and maintaining the spacing between each of the dielectric material layers or the spacing between each of the dielectric material layers and the target component.

Preferably, the dielectric apparatus may further include a gap area.

Preferably, part of a surface of the gap area and an outer surface of the structural body form a continuous surface.

Preferably, the positioning component may be formed of at least one dielectric material, the equivalent dielectric constant of which ranges from greater than 1 to not greater than 200000.

Preferably, the frequency-tuning component may be formed of at least one set of members matched to each other to be able to move relatively and generate displacement, and the members that may move relatively and generate displacement are respectively disposed on the structure body and the positioning component or on each of the dielectric material layers in the structure body; the user may adjust the relative displacement between the members to adjust the spacing between the structural body and the target component, or the spacing between each of the dielectric layers in the structural body, thus achieving the purpose of tuning the frequency.

Preferably, the frequency-tuning component may be formed of members that are matched to each other and may move relatively, such as slide rails, slide blocks, slide block positioners, tenons, slide grooves, and the like, together with the positioning component, which is used to control and maintain the spacing between the structural body and the target component in the apparatus, or the spacing between each of the dielectric layers in the structural body.

Preferably, the frequency-tuning component may be formed of members that are matched to each other and may move relatively, such as guide pins, positioning holes in the apparatus, gaskets, and the like, together with the positioning component, which is used to control and maintain the spacing between the structural body and the target component in the apparatus, or the spacing between each of the dielectric layers in the structural body.

Preferably, the frequency-tuning component may be formed of members that are matched to each other and may move relatively, such as internal and external screw threads adopted in the apparatus, together with the positioning component, which is used to control and maintain the spacing between the structural body and the target component in the apparatus, or the spacing between each of the dielectric layers in the structural body.

Preferably, the frequency-tuning component may be formed of members that are matched to each other and may move relatively, such as gears and gear racks, together with the positioning component, which is used to control and maintain the spacing between the structural body and the target component in the apparatus, or the spacing between each of the dielectric layers in the structural body.

Preferably, the frequency-tuning component may be formed of hinges that may move relatively, together with the positioning component, which is used to control and maintain the spacing between the structural body and the target component in the apparatus, or the spacing between each of the dielectric layers in the structural body.

Preferably, the frequency-tuning component may be formed of a piezoelectric ceramic actuator that may move relatively, together with the positioning component, which is used to control and maintain the spacing between the structural body and the target component in the apparatus, or the spacing between the dielectric layers in the dielectric structural body.

Preferably, the apparatus may be formed of a plurality of frequency-tuning components to tune the corresponding working frequency of the plurality of blocks in the apparatus.

Preferably, the frequency-tuning component may manually perform the setting of the spacing between the structure body and the target component in the apparatus or the spacing between each of the dielectric layers in the structural body through the mechanical structure. The frequency-tuning component may also be integrated through electromechanics, and the frequency-tuning component may be driven by the external electric control signal line to achieve the purpose of semi-automatic or fully-automatic control.

The dielectric apparatus and the arrangement method thereof according to the concept of the present disclosure have at least the following advantages: (1) The present disclosure may be made of a dielectric material, which has a simple structure and manufacturing process, thus being advantageous to mass production; (2) No external power or signal is required, thus making it convenient to install and use; (3) Except for semi-automatic or fully automatic control, the apparatus does not require electricity for operation, which may save electricity and operating costs; (4) The dielectric apparatus is not a signal emission source, so there is no hidden danger to biological safety due to electromagnetic wave radiation; (5) Under the requirement of fixed working frequency, a greater application latitude may be obtained in terms of dielectric constant, physical size, and structure of the target component under a specific locked working frequency; (6) The working frequency may be tuned according to users' needs.

### BRIEF DESCRIPTION OF THE DRAWINGS

FIG. 1 is an admittance diagram according to the prior art.

FIG. 2A and FIG. 2B are cross-sectional views depicting the dielectric apparatus according to an embodiment of the present disclosure.

FIG. 3A and FIG. 3B are cross-sectional views depicting the dielectric apparatus according to an embodiment of the present disclosure.

FIG. 4A to FIG. 4C are cross-sectional views depicting the dielectric apparatus according to an embodiment of the present disclosure.

FIG. 5A to FIG. 5C are cross-sectional views depicting the dielectric apparatus according to an embodiment of the present disclosure.

FIG. 6A to FIG. 6E are cross-sectional views depicting the dielectric apparatus according to an embodiment of the present disclosure.

FIG. 7 is a schematic diagram depicting the use of a dielectric apparatus coupled to a target component according to an embodiment of the present disclosure.

FIG. 8A and FIG. 8B respectively are curve diagrams depicting the reflectance and transmittance at different spacing when using electromagnetic waves from 2 GHz to 6 GHz to penetrate a glass with a thickness of 6 mm and a dielectric constant of 7 under the condition of being bonded to the structural body with a thickness of 4.8mm and a dielectric constant of 7.

FIG. 9 is a curve diagram depicting the frequency and bandwidth of the maximum transmittance at different spacing when using electromagnetic waves to penetrate a glass with a thickness of 6 mm and a dielectric constant of 7 under the condition of being bonded to the structural body with a thickness of 4.8mm and a dielectric constant of 7.

FIG. 10A is a curve diagram depicting the transmittance variation when using electromagnetic waves from 2 GHz to 6 GHz to penetrate the glass with a dielectric constant of 7 and different thickness tolerance being bonded to the structural body with a thickness of 3.86mm and a dielectric constant of 7 under the condition of the spacing being 1mm.

FIG. 10B is a column graph depicting frequency deviation of each curve and working frequency in FIG. 10A under the condition of the target working frequency being set to 5.2 GHz, as well as the results of frequency correction by adjusting the spacing between the dielectric structural body and the target component in the apparatus according to the present disclosure.

### DESCRIPTION OF THE PREFERRED EMBODIMENTS

To illustrate the technical features, contents, advantages, and achievable effects of the present disclosure, the embodiments together with the attached drawings are described in detail as follows. However, the drawings are used only for the purpose of indicating and supporting the specification, which is not necessarily the real proportion and precise configuration after the implementation of the present disclosure. Therefore, the relations of the proportion and configuration of the attached drawings should not be interpreted to limit the actual scope of implementation of the present disclosure.

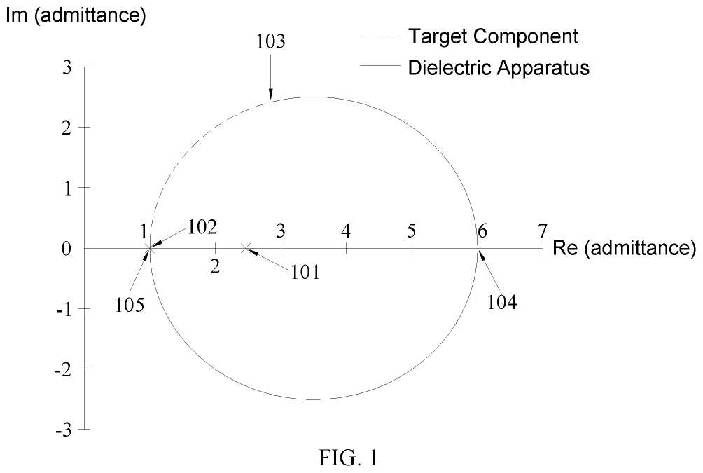

Please refer to FIG. 1, which is an admittance diagram according to the prior art. Take the target component (shown by position 101) of εₛ=εᵣ=6 being placed in the environment (shown by position 102) of εᵣ=1 as an example. As the thickness of the target component gradually increases from 0 to tₛ, the admittance valueαₛ moves from position 102 to position 103 along the circle in a clockwise direction. Next, the structural body formed of the first dielectric material with a dielectric constant of ε₁=εᵣ=6 is selected to bond the aforementioned target component to form a composite structure; as the thickness of the apparatus gradually increases from 0 to t₁, after passing position 104 of the phase thickness

$$( 2 * n - 1 ) * \frac{π}{2}$$

of the real part axis (Re) from position 103 shown in the figure, the admittance value αₛ+α₁ of the composite structure further intersects with position 105 of the phase thickness n*π of the real part axis (Re); hence, t₁ corresponding to the phase thickness n*π is the optimal thickness of the apparatus, so that the composite structure has increased transmittance in a specific electromagnetic wave spectrum; wherein, the n value in the aforementioned two equations is a non-zero positive integer. For a structural body of apparatus made of multi-layer hetero-dielectric constant materials, as well as a target component or positioning component formed of multi-layer dielectric materials as dielectrics which is located in an area where a RF signal is set to pass, the compensation analysis method thereof is the same as that as mentioned above. In addition, in consideration of bandwidth and manufacturing processes in a practical application, +/−25% is considered the acceptable range of thickness variation for the thickness of each layer in the structural body of apparatus.

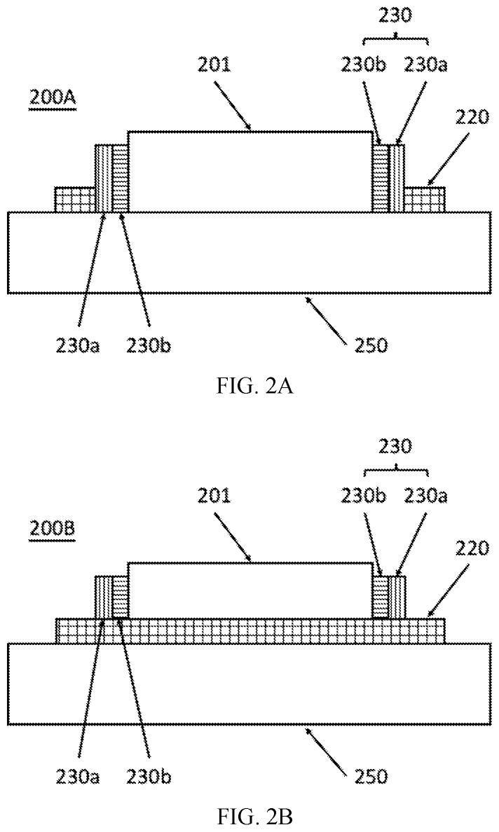

The thickness of the structural body of apparatus corresponding to different working frequencies is determined based on the admittance compensation technique shown in FIG. 1, and the frequency-tuning component is used to adjust the spacing between each of the dielectric material layers or between the structural body and the target component in the apparatus; next, please refer to FIG. 2A and FIG. 2B, and FIG. 2A and FIG. 2B respectively depict cross-sectional views of the dielectric structure according to different embodiments of the present disclosure. Wherein, the dielectric apparatus 200A in FIG. 2A is formed of a structural body 201, a positioning component 220, and a frequency-tuning component 230. The structural body 201 is formed of a dielectric material layer with a dielectric constant value ranging from greater than 1 to not greater than 200000. The structural body 201 and the frequency-tuning component 230 are coupled to the target component 250 by means of the positioning component 220. The frequency-tuning component 230 is formed of the first member 230a and the second member 230b that may be matched to each other to be able to move relatively and generate displacement, and the first member 230a and the second member 230b are manufactured or disposed on the positioning component 220 and the structural body 201 respectively, thereby adjusting and maintaining the spacing between the structural body 201 and the target component 250 through the frequency-tuning component 230 to achieve the purpose of tuning the frequency. For a composite structure after the dielectric apparatus 200A and the target component 250 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 250 is not less than λ/8.

According to another embodiment of the present disclosure, the dielectric apparatus 200B in FIG. 2B is formed of a structural body 201, a positioning component 220, and a frequency-tuning component 230. The structural body 201 is formed of a dielectric material layer with a dielectric constant value ranging from greater than 1 to not greater than 200000. The structural body 201 and the frequency-tuning component 230 are coupled to the target component 250 by means of the positioning component 220, the positioning component 220 may be partially interposed between the structural body 201 and the target component 250, and the positioning component in the area where the RF signal passes may be formed of a second dielectric material with a dielectric constant value ranging from greater than 1 to not greater than 200000. The frequency-tuning component 230 is formed of the first member 230a and the second member 2309b that may be matched to each other to be able to move relatively and generate displacement, and the first member 230a and the second member 230b are manufactured or disposed on the positioning component 220 and the structural body 201 respectively, thereby adjusting and maintaining the spacing between the structural body 201 and the target component 250 through the frequency-tuning component 230, or the spacing between the structure body 201 and the positioning component 220 to achieve the purpose of tuning the frequency. For a composite structure after the dielectric apparatus 200B and the target component 250 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 250 is not less than λ/8.

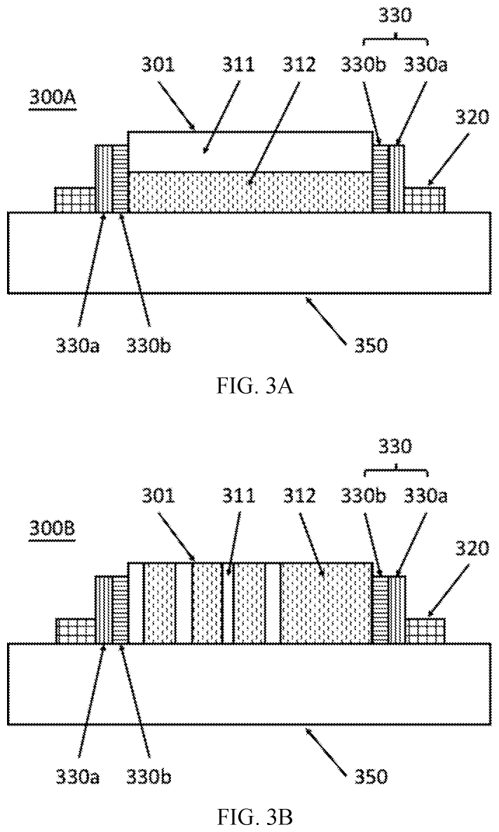

Next, please refer to FIG. 3A and FIG. 3B; FIG. 3A and FIG. 3B are based on the embodiment of FIG. 2A and the embodiment after the dielectric material of the structural body 201 is modified. In the same way, the dielectric material of the structural body 201 in FIG. 2B may be modified, together with the positioning component 220 in FIG. 2B to meet different installation requirements.

According to another embodiment of the present disclosure, the dielectric apparatus 300A in FIG. 3A is formed of a structural body 301, a positioning component 320, and a frequency-tuning component 330. Wherein, the structural body 301 is formed of a first dielectric material layer 311 and a second dielectric material layer 312, the dielectric constant value of the dielectric material used in the first dielectric material layer 311 and the second dielectric material layer 312 ranges from greater than 1 to not greater than 200000, and the first dielectric material layer 311 and the second dielectric material layer 312 may be partially coupled and stacked. The structural body 301 and the frequency-tuning component 330 are coupled to the target component 350 by means of the positioning component 320. The frequency-tuning component 330 is formed of the first member 330a and the second member 330b that may be matched to each other to be able to move relatively and generate displacement, and the first member 330a and the second member 330b are manufactured or disposed on the positioning component 320 and the structural body 301 respectively, thereby adjusting and maintaining the spacing between the structural body 301 and the target component 350 through the frequency-tuning component 330 to achieve the purpose of tuning the frequency. For a composite structure after the dielectric apparatus 300A and the target component 350 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 350 is not less than λ/8.

According to another embodiment of the present disclosure, the dielectric apparatus 300B in FIG. 3B is formed of a structural body 301, a positioning component 320, and a frequency-tuning component 330. Wherein, the structural body 301 is formed of the dielectric materials of a first dielectric material layer 311 and a second dielectric material layer 312, the dielectric constant value of the dielectric materials used in the first dielectric material layer 311 and the second dielectric material layer 312 ranges from greater than 1 to not greater than 200000, and each block is coupled using a partitioned or a mixed method as well as partial surface bonding to form the structural body 301. The structural body 301 and the frequency-tuning component 330 are coupled to the target component 350 by means of the positioning component 320. The frequency-tuning component 330 is formed of the first member 330a and the second member 330b that may be matched to each other to be able to move relatively and generate displacement, and the first member 330a and the second member 330b are manufactured or disposed on the positioning component 320 and the structural body 301 respectively, thereby adjusting and maintaining the spacing between the structural body 301 and the target component 350 through the frequency-tuning component 330 to achieve the purpose of tuning the frequency. For a composite structure after the dielectric apparatus 300B and the target component 350 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 350 is not less than λ/8.

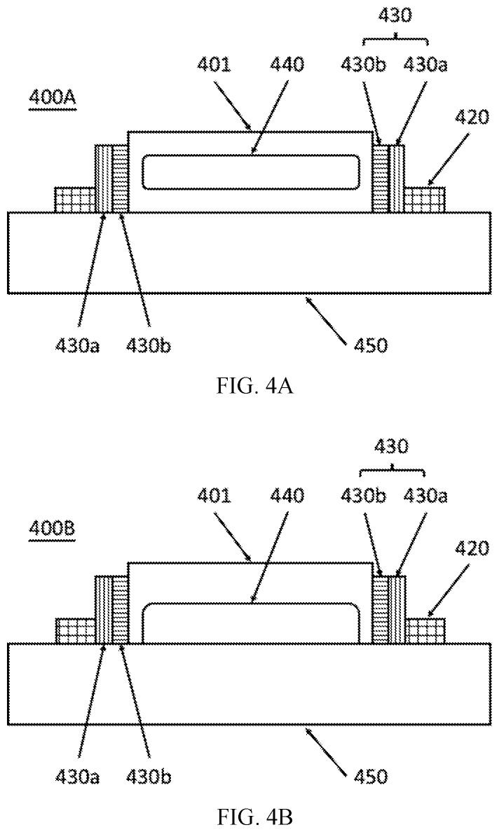

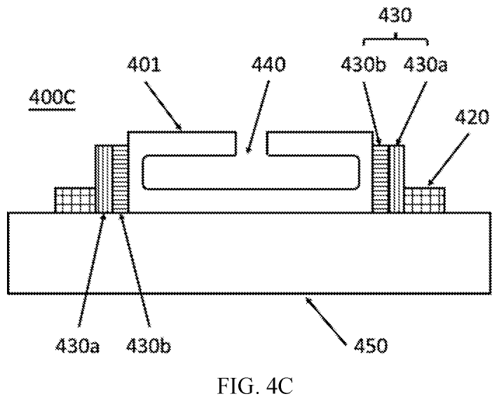

Next, please refer to FIG. 4A to FIG. 4C; FIG. 4A to FIG. 4C are based on the embodiment of FIG. 2A and the embodiment after a gap area structure is added to the structural body 201 for modification. In the same way, the gap area may be added to the dielectric material structural body 201 in FIG. 2B for modification, together with the positioning component 220 in FIG. 2B to meet different installation requirements.

According to another embodiment of the present disclosure, the dielectric apparatus 400A in FIG. 4A is formed of a structural body 401, a positioning component 420, and a frequency-tuning component 430. The structural body 401 is formed of a dielectric material with a dielectric constant value ranging from greater than 1 to not greater than 200000. The gap area 440 is positioned in the structural body 401 and does not make contact with the target component 450. The structural body 401 and the frequency-tuning component 430 are coupled to the target component 450 by means of the positioning component 420. The frequency-tuning component 430 is formed of the first member 430a and the second member 430b that may be matched to each other to be able to move relatively and generate displacement, and the first member 430a and the second member 430b are manufactured or disposed on the positioning component 420 and the structural body 401 respectively, thereby adjusting and maintaining the spacing between the structural body 401 and the target component 450 through the frequency-tuning component 430 to achieve the purpose of tuning the frequency. For a composite structure after the dielectric apparatus 400A and the target component 450 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 450 is not less than λ/8.

According to another embodiment of the present disclosure, the dielectric apparatus 400B in FIG. 4B is formed of a structural body 401, a positioning component 420, and a frequency-tuning component 430. The structural body 401 is formed of a dielectric material with a dielectric constant value ranging from greater than 1 to not greater than 200000. The gap area 440 is disposed in the structure body 401 and a partial surface of the gap area 440 makes contact with the outer surface of the structural body 401 to form a continuous surface. The structural body 401 and the frequency-tuning component 430 are coupled to the target component 450 by means of the positioning component 420. The frequency-tuning component 430 is formed of the first member 430a and the second member 430b that may be matched to each other to be able to move relatively and generate displacement, and the first member 430a and the second member 430b are manufactured or disposed on the positioning component 420 and the structural body 401 respectively, thereby adjusting and maintaining the spacing between the structural body 401 and the target component 450 through the frequency-tuning component 430 to achieve the purpose of tuning the frequency. For a composite structure after the dielectric apparatus 400B and the target component 450 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 450 is not less than λ/8.

According to another embodiment of the present disclosure, the dielectric apparatus 400C in FIG. 4C is formed of a structural body 401, a positioning component 420, and a frequency-tuning component 430. The structural body 401 is formed of a dielectric material with a dielectric constant value ranging from greater than 1 to not greater than 200000. The gap area 440 is disposed in the structure body 401 and a partial surface of the gap area 440 makes contact with the outer surface of the structural body 401 to form a continuous surface. The structural body 401 and the frequency-tuning component 430 are coupled to the target component 450 by means of the positioning component 420. The frequency-tuning component 430 is formed of the first member 430a and the second member 430b that may be matched to each other to be able to move relatively and generate displacement, and the first member 430a and the second member 430b are manufactured or disposed on the positioning component 420 and the structural body 401 respectively, thereby adjusting and maintaining the spacing between the structural body 401 and the target component 450 through the frequency-tuning component 430 to achieve the purpose of tuning the frequency. For a composite structure after the dielectric apparatus 400C and the target component 450 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 450 is not less than λ/8. The difference between FIG. 4C and FIG. 4B lies in the different positions where the partial surface of the gap area 440 and the outer surface of the structural body 401 form a continuous surface.

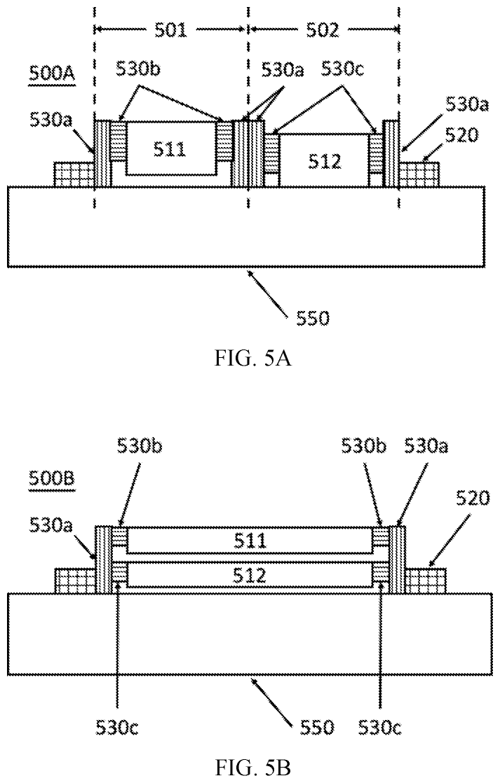

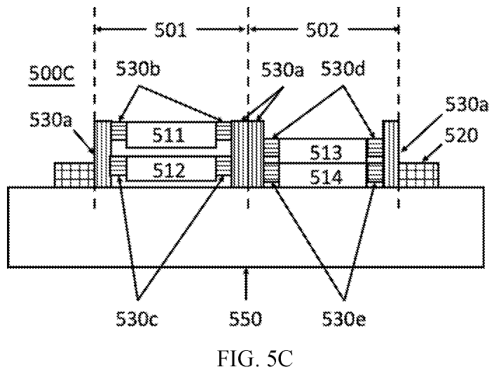

Next, please refer to FIG. 5A to FIG. 5C; the frequency-tuning components in FIG. 5A to FIG. 5C may be grouped to conduct independent partitioned control on different dielectric structural blocks or dielectric structural bodies to generate more use requirements for different frequency combinations.

According to another embodiment of the present disclosure, the dielectric apparatus 500A in FIG. 5A is formed of two first block 501 and second block 502 that may independently tune the frequency, a frequency-tuning component, and a positioning component 520, and the positioning component 520 couples the first block 501 and the second block 502 to the target component 550. The first block 501 includes a first structural body 511 made of a material with a dielectric constant ranging from 1 to 200000 and a frequency-tuning component formed of a first member 530a and a second member 530b; the second block 502 includes a second structural body 512 made of a material with a dielectric constant ranging from 1 to 200000 and a frequency-tuning component formed of the first member 530a and the third member 530c. The first member 530a and the second member 530b as well as the first member 530a and the third member 530c are respectively matched to each other to become frequency-tuning components that may move relatively and generate displacement; the first member 530a needs to be manufactured or disposed on the positioning component 520; the second member 530b and the third member 530c need to be manufactured or disposed on the first structural body 511 and the second structural body 512 respectively, thereby respectively adjusting the spacing between the first structural body 511 and the second structural body 512 and the target component 550 through the corresponding frequency-tuning components, so as to achieve the purpose of tuning the frequency by partition. For a composite structure formed of the first block 501 after the dielectric apparatus 500A and the target component 550 are coupled, under the transmission state of the RF signal with the working frequency f₁ and the corresponding wavelength λ₁, the minimum equivalent diameter of the dielectric structure corresponding to the composite structure on the projected area of the surface through which the RF signal passes on the surface of the target component 550 is not less than λ₁/8; For a composite structure formed of the second block 502, under the transmission state of the RF signal with the working frequency f₂ and the corresponding wavelength λ₂, the minimum equivalent diameter of the dielectric structure corresponding to the composite structure on the projected area of the surface through which the RF signal passes on the surface of the target component 550 is not less than λ₂/8.

According to another embodiment of the present disclosure, the dielectric apparatus 500B in FIG. 5B is formed of a first structural body 511, a second structural body 512, a frequency-tuning component, and a positioning component 520, and the positioning component 520 couples the first structural body 511, the second structural body 512, and the frequency-tuning component to the target component 550. The first structural body 511 and the second structural body 512 may be made of the same or different dielectric materials with dielectric constant values ranging from 1 to 200000. The frequency-tuning component is formed of a first member 530a, a second member 530b, and a third member 530_{c}; the first member 530a and the second member 530b as well as the first member 530a and the third member 530c are respectively matched to each other to become frequency-tuning components that may move relatively and generate displacement; the first member 530a needs to be manufactured or disposed on the positioning component 520; the second member 530b and the third member 530c need to be manufactured or disposed on the first structural body 511 and the second structural body 512 respectively, thereby respectively adjusting the spacing between the first structural body 511 and the second structural body 512 through the corresponding frequency-tuning components, or the spacing between the second structural body 512 and the target component 550, so as to achieve the purpose of tuning the frequency. For a composite structure after the dielectric apparatus 500B and the target component 550 are coupled, under the transmission state of the RF signal with the working frequency f and the corresponding wavelength λ, the minimum equivalent diameter of the dielectric structure corresponding to the composite structure on the projected area of the surface through which the RF signal passes on the surface of the target component 550 is not less than λ/8.

According to another embodiment of the present disclosure, the dielectric apparatus 500C in FIG. 5C is formed of two first block 501 and second block 502 that may independently tune the frequency, a frequency-tuning component, and a positioning component 520, and the positioning component 520 couples the first block 501 and the second block 502 to the target component 550. The first block 501 includes a first structural body 511, a second structural body 512, and a frequency-tuning component formed of a first member 530a, a second member 530b, and a third member 530_{c}; the second block 502 includes a third structural body 513, a fourth structural body 514, and a frequency-tuning component formed of a first member 530a, a fourth member 530d, and a fifth member 530e. Wherein, each structural body may be made of the same or different dielectric materials with dielectric constant values ranging from 1 to 200000. The frequency-tuning component is formed of a first member 530a, a second member 530b, a third member 530c, a fourth member 530d, and a fifth member 530e; the first member 530a and the second member 530b as well as the first member 530a and the third member 530c are respectively matched to each other in the first block 501 to become frequency-tuning components that may move relatively and generate displacement; the first member 530a needs to be manufactured or disposed on the positioning component 520; the second member 530b and the third member 530c need to be manufactured or disposed on the first structural body 511 and the second structural body 512 respectively, thereby respectively adjusting and maintaining the mutual positions among the first structural body 511, the second structural body 512, and the target component 550 through the corresponding frequency-tuning components, so as to achieve the purpose of tuning the frequency within the range of the first block 501. The purpose of tuning the frequency within the range of the second block 502 is achieved by the same way of adjusting the mutual positions among the third structural body 513, the fourth structural body 514, and the target component 550. For a composite structure formed of the first block 501 after the dielectric apparatus 500C and the target component 550 are coupled, under the transmission state of the RF signal with the working frequency f₁ and the corresponding wavelength λ₁, the minimum equivalent diameter of the dielectric structure corresponding to the composite structure on the projected area of the surface through which the RF signal passes on the surface of the target component 550 is not less than λ₁/8; For a composite structure formed of the second block 502, under the transmission state of the RF signal with the working frequency f₂ and the corresponding wavelength λ₂, the minimum equivalent diameter of the dielectric structure corresponding to the composite structure on the projected area of the surface through which the RF signal passes on the surface of the target component 550 is not less than λ₂/8.

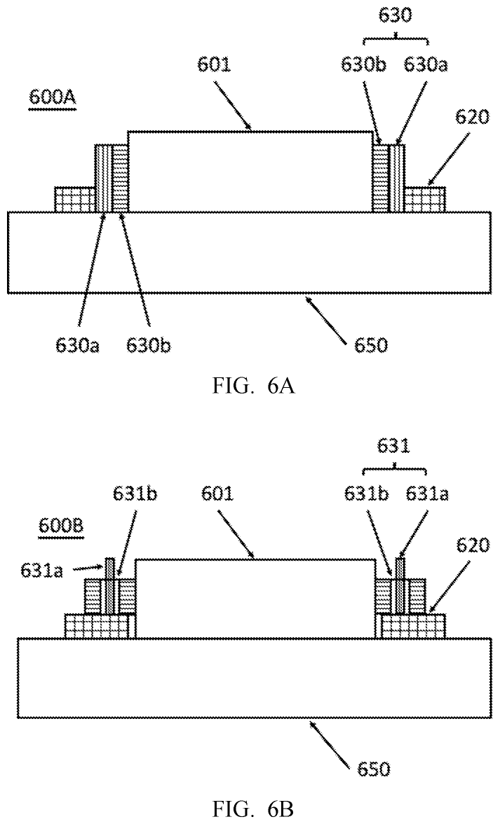

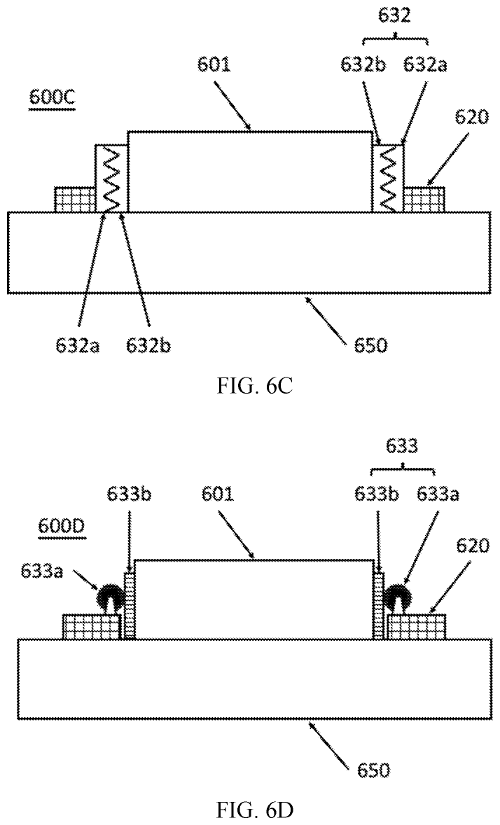

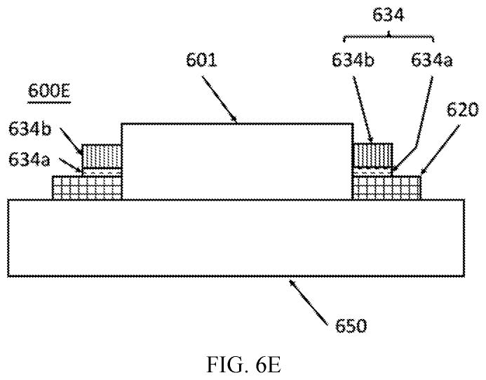

Next, please refer to FIG. 6A to FIG. 6E; FIG. 6A to FIG. 6E depict several mechanisms that may realize the purpose of tuning frequency to be used as frequency-tuning components. The mechanisms actually applied to the tuning components may include the mechanisms described in the figures, which are not limited to the mentioned mechanisms.

According to another embodiment of the present disclosure, the dielectric apparatus 600A in FIG. 6A includes a structural body 601, a positioning component 620, and a frequency-tuning component 630, and the positioning component 620 couples the structural body 601 and the frequency-tuning component 630 to the target component 650. The frequency-tuning component 630 may be formed of a first member 630a and a second member 630b; the first member 630a may be a slide rail or a slide groove, and the second member 630b may be a slide block or a tenon-like structure that may be embedded in the structural body; the first member 630a and the second member 630b are manufactured or disposed on the positioning component 620 and the structural body 601 respectively, and the first member 630a and the second member 630b are matched to each other to become components that may move relatively and generate displacement. The frequency tuning may be achieved by adjusting the frequency-tuning component 630 to adjust and maintain the spacing between the structural body 601 and the target component 650.

According to another embodiment of the present disclosure, the dielectric apparatus 600B in FIG. 6B includes a structural body 601, a positioning component 620, and a frequency-tuning component 631, and the positioning component 620 couples the structural body 601 and the frequency-tuning component 631 to the target component 650. The frequency-tuning component 631 may be formed of a first member 631a and a second member 631b; the first member 631a may be a guide pin, and the second member 631b may be a structure with a positioning hole; the first member 631a and the second member 631b are manufactured or disposed on the positioning component 620 and the structural body 601 respectively, and the first member 631a and the second member 631b are matched to each other to become components that may move relatively and generate displacement. The frequency tuning may be achieved by adjusting the frequency-tuning component 631 to adjust and maintain the spacing between the structural body 601 and the target component 650.

According to another embodiment of the present disclosure, the dielectric apparatus 600C in FIG. 6C includes a structural body 601, a positioning component 620, a frequency-tuning component 632, and the positioning component 620 couples the structural body 601 and the frequency-tuning component 632 to the target component 650. The frequency-tuning component 632 may be formed of a first member 632a and a second member 632b; the first member 632a may be a structure with an internal thread, and the second member 632b may be a structure with an external thread; the first member 632a and the second member 632b are manufactured or disposed on the positioning component 620 and the structural body 601 respectively, and the first member 632a and the second member 632b are matched to each other to become components that may move relatively and generate displacement. The frequency tuning may be achieved by adjusting the frequency-tuning component 632 to adjust and maintain the spacing between the structural body 601 and the target component 650.

According to another embodiment of the present disclosure, the dielectric apparatus 600D in FIG. 6D includes a structural body 601, a positioning component 620, and a frequency-tuning component 633, and the positioning component 620 couples the structural body 601 and the frequency-tuning component 633 to the target component 650. The frequency-tuning component 633 may be formed of a first member 633a and a second member 633b; the first member 633a may be a gear mechanism, and the second member 633b may be a gear rack structure matched to gears; the first member 633a and the second member 633b are manufactured or disposed on the positioning component 620 and the structural body 601 respectively, and the first member 633a and the second member 633b are matched to each other to become components that may move relatively and generate displacement. The frequency tuning may be achieved by adjusting the frequency-tuning component 633 to adjust and maintain the spacing between the structural body 601 and the target component 650.

According to another embodiment of the present disclosure, the dielectric apparatus 600E in FIG. 6E includes a structural body 601, a positioning component 620, and a frequency-tuning component 634, and the positioning component 620 couples the structural body 601 and the frequency-tuning component 634 to the target component 650. The frequency-tuning component 634 may be formed of a first member 634a and a second member 634b; the first member 634a may be a piezoelectric ceramic actuator, and the second member 634b may be an attached support structure; the first member 634a and the second member 634b are manufactured or disposed on the positioning component 620 and the structural body 601 respectively, and the first member 634a and the second member 634b are matched to each other to become components that may move relatively and generate displacement. The frequency tuning may be achieved by adjusting the frequency-tuning component 634 to adjust and maintain the spacing between the structural body 601 and the target component 650.

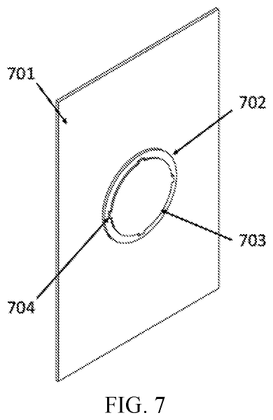

Please refer to FIG. 7, which depicts a schematic diagram of the joining state of the target component 701 joining the structural body 703 and the frequency-tuning component 704 through the positioning component 702 according to an embodiment of the present disclosure; the frequency-tuning component 704 shown in the figure is an embodiment of a slide groove and tenon-like structure matched to each other. The target component 701 may be building components such as glass, cement, wood, ceramic, plastic, and other dielectric materials; however, the present disclosure is not limited to thereto; the target component may be any component that requires enhancing the transmittance of RF signals thereon.

In addition, since the dielectric constant changes according to the working frequency, types of specific materials need to be correspondingly adjusted depending on the dielectric constant of the target component in a working spectrum. The following are representative materials for an apparatus body structure that may be used but not limited thereto, and the materials include low dielectric constant materials: PTFE, PE, PC, PVC, Acrylic, PU, Epoxy, Silicone, and the like; medium dielectric constant materials: quartz, glass, aluminum oxide crystals and ceramics, aluminum nitride crystals and ceramics, magnesium oxide crystals and ceramics, silicon carbide crystals and ceramics, zirconia crystals and ceramics, and the like; high dielectric constant materials: titanium oxide crystals and ceramics, barium titanate polymer composites, and the like.

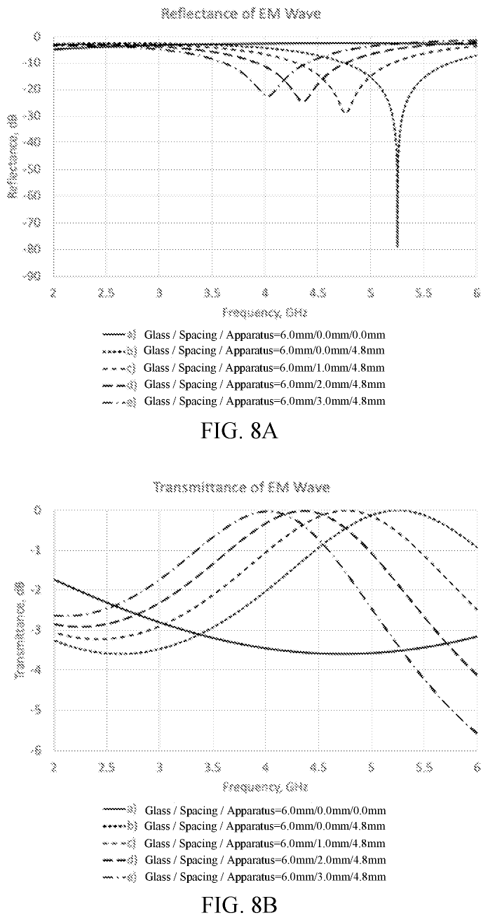

Please refer to FIG. 8A and FIG. 8B, which respectively are curve diagrams depicting the reflectance and transmittance when using wireless RF electromagnetic waves from 2 GHz to 6 GHz to penetrate a glass with a thickness of 6 mm and a dielectric constant of 7, with the use of the apparatus of the present disclosure in FIG. 2A under the condition of different set spacing; the dielectric structural body used in the apparatus is a dielectric material with a dielectric material with a thickness of 4.8 mm and a dielectric constant of 7 in this test. The apparatus structure used in FIG. 8A and FIG. 8B is shown in FIG. 2A, and the spectral test results of the glass from 2 GHZ to 6 GHz show a very large reflection loss in this spectrum. According to the general evaluation standard of the communications industry, −10 dB reflectance is adopted as the evaluation, which may be used as the threshold for communication use and the basis for evaluating bandwidth, and the glass test results show that there is no suitable frequency band for communication use. When glass is used with the apparatus of the present disclosure and the structural body of the dielectric apparatus is attached to the glass, FIG. 8A shows that the lowest reflectance of −79.138 dB appears at 5.249 GHz, the usable bandwidth is 0.997 GHz, and FIG. 8B shows that the transmittance increases from −3.516 dB in the original glass state to −5.30 E-08 dB at 5.249 GHz. The aforementioned results show that the glass used together with the apparatus of the present disclosure may effectively improve the transmittance of the RF signal at 5.249 GHz and have a larger bandwidth for communication use when the dielectric structural body and the glass are in a state of being attached to each other. When the spacing between the dielectric structural body and the glass is adjusted by the frequency-tuning component to 1.0 mm, 2.0 mm, and 3.0 mm, it may be found from FIG. 8A that the valley value of the lowest reflectance moves toward the low frequency direction, the corresponding reflectance frequencies to each spacing are 4.758 GHz, 4.357 GHz, and 4.024 GHz, the corresponding reflectance values are −29.089 dB, −24.625 dB, and −22.518 GHz, and the corresponding bandwidth values are 0.906 GHz, 0.834 GHz, and 0.783 GHz. It may be obtained from FIG. 8B that the transmittance values of the aforementioned frequencies corresponding to glass only are −3.560 dB, −3.554 dB, and −3.458 dB respectively, and the transmittance values of the aforementioned frequencies corresponding to glass together with the apparatus of the present disclosure are −0.005 dB, −0.015 dB, and −0.024 dB respectively. From the results as mentioned above, it may be found that by adjusting the spacing between the dielectric structural body and the glass, the composite structure formed of the glass and the apparatus of the present disclosure may allow different specific working frequencies of RF signals to have better signal penetration performance and larger bandwidth for communication.

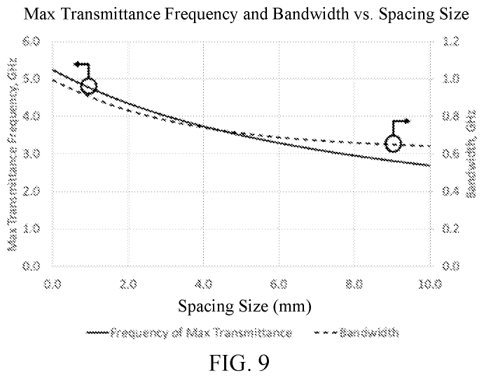

Please refer to FIG. 9; FIG. 9, having the same test disposition as FIG. 8A and FIG. 8B, shows the frequency curve and the bandwidth curve of the transmittance peak values corresponding to the spacing between different glasses and the dielectric structural body, when using electromagnetic waves to penetrate a glass with a thickness of 6 mm and a dielectric constant of 7 under the condition of being bonded to the dielectric apparatus of the structural body with a thickness of 4.8 mm and a dielectric constant of 7. The figure shows that when the spacing is adjusted from 0 mm to 10 mm, the RF signal frequency corresponding to the transmittance peak value at each spacing may be adjusted from 5.249 GHz to 2.703 GHz, and the bandwidth values are all greater than 0.5 GHz; the aforementioned performance is sufficient to meet the needs of working frequency and bandwidth for most RF wireless communication in this spectrum range.

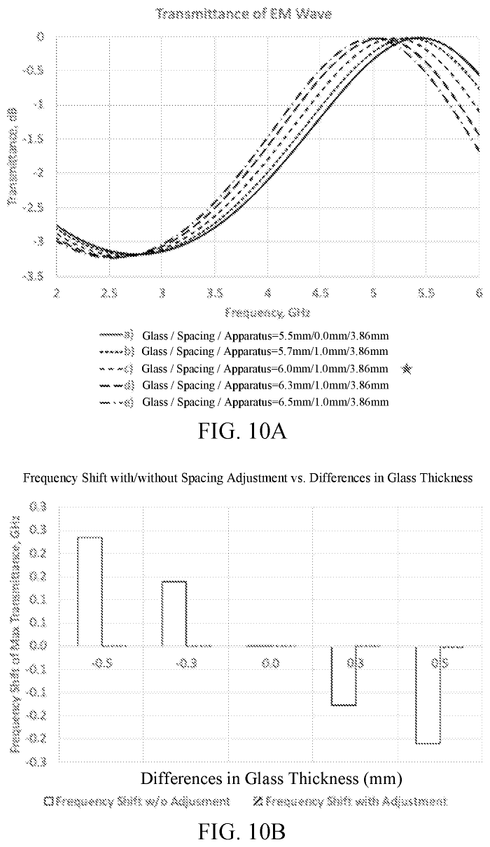

Please refer to FIG. 10A; for glass with a thickness of 6 mm and a dielectric constant of 7 under the condition of the corresponding working frequency at 5.2 GHz, a structural body with a dielectric constant of 7 and a thickness of 3.86 may be used with a spacing of 1 mm to achieve the best transmittance performance at 5.2 GHz for the disposition of the present dielectric apparatus, as curve c shown in FIG. 10A. In the industrial standards for architectural glass, the national and industrial standard specifications stipulated by different countries may vary depending on their industrial capacities. Take glass with a thickness of 6 mm as an example; the more common thickness tolerance is ±0.3 mm, but the thickness tolerance of ±0.5 mm may also appear for some national standards or industry standards. Accordingly, in addition to the test on glass with a thickness of 6 mm, a test is also conducted on 5.5 mm, 5.7 mm, 6.3 mm, and 6.5 mm glass, and the test results are shown as curves a, b, d, and e in FIG. 10A respectively. It may be found from the figure that, adopting the same disposition of the present disclosure, different thicknesses of glass still have different degrees of transmittance improvement when the working frequency is set to 5.2 GHz, but thicknesses of different glass may have an effect of frequency shift on the frequency corresponding to the transmittance peak value of the transmittable electromagnetic waves. A larger thickness deviation may produce a larger frequency shift, the frequency shift caused by the glass with thickness 5.5 mm (thickness deviation value −0.5 mm) is 0.235 GHz, and the frequency shift caused by the glass with thickness 6.5 mm (thickness deviation value 0.5 mm) is −0.210 GHz, but this phenomenon may become more severe as the used working frequency increases.

Please refer to FIG. 10B. In FIG. 10A, multiple curve diagrams are shown to depict the problem of frequency shift of the glass thickness under the same apparatus disposition. Since the dielectric apparatus includes frequency-tuning components, the frequency of electromagnetic waves that may pass through the composite structure may be tuned by adjusting the spacing between the structural body and the glass, thus compensating the frequency shift caused by the deviation of the thickness of each glass. The hollow bar graph in FIG. 10B is the frequency shift resulting from the thickness deviation of each glass in FIG. 10A, and the sloping bar graph is the result of structural body correction by adjusting the spacing between the dielectric structural body and the glass. Through the comparison of the results of the hollow bar graph and the sloping bar graph, it may be found that the frequency shift effect caused by the thickness deviation of the glass may be effectively corrected by adjusting the frequency-tuning components in the apparatus of the present disclosure. Therefore, this method may also be used to solve the frequency shift effect caused by the deviation of the building component size or dielectric constant when the present disclosure is coupled to different building components in practical applications.

Through the analysis of the admittance of the corresponding working spectrum via the structure formed of dielectric materials, the composite structure produced after the dielectric apparatus disclosed in the present disclosure is coupled to the building components may adjust the admittance value in whole blocks or in sub-blocks, thus enhancing the transmittance of working spectrum signals in different frequency bands in this composite structure, and achieving the purpose of spectrum adjustment by adjusting the spacing between the dielectric structural body and the coupled building components according to the communication requirements.

The above description is merely illustrative rather than restrictive. Any equivalent modifications or alterations without departing from the spirit and scope of the present disclosure are intended to be included in the following claims.

What is claimed is:

1. A frequency tunable dielectric apparatus applied to building components, which is used to tune a working frequency of an RF signal passing through a building component and increase transmittance and transmission bandwidth of the RF signal, the dielectric apparatus comprising:
a structural body formed of a dielectric material;
a frequency-tuning component; and
a positioning component configured to couple the structural body and the frequency-tuning component to a target component;
wherein a dielectric constant value of each dielectric material comprised in the structural body and the positioning component allowing the RF signal to pass through ranges from greater than 1 to not greater than 200000; the positioning component couples the structural body formed of the dielectric material to the target component to form a composite structure; the composite structure correspondingly has the working frequency; a minimum equivalent diameter of a dielectric structure corresponding to the composite structure on a projected area of a surface through which the RF signal passes on a surface of the target component is not less than one-eighth of a working wavelength corresponding to the working frequency.

2. The frequency tunable dielectric apparatus applied to building components according to claim 1, further comprising a plurality of blocks formed of a dielectric material, wherein each of the blocks independently and correspondingly has a specific working frequency.

3. The frequency tunable dielectric apparatus applied to building components according to claim 1, further comprising a plurality of blocks formed of a dielectric material, wherein each of the blocks is independently controlled to correspondingly have a specific working frequency.

4. The frequency tunable dielectric apparatus applied to building components according to claim 1, wherein the positioning component comprises a dielectric material layer, and an equivalent dielectric constant value of a dielectric material forming the dielectric material layer ranges from greater than 1 to not greater than 200000.

5. The frequency tunable dielectric apparatus applied to building components according to claim 1, wherein the positioning component is partially interposed between the structural body and the target component.

6. The frequency tunable dielectric apparatus applied to building components according to claim 1, wherein the frequency-tuning component is formed of at least two members matched to each other to be able to move relatively and generate displacement, which are used to adjust and maintain a spacing between the structural body and the target component in the dielectric apparatus, or between each of the structural bodies in the dielectric apparatus.

7. The frequency tunable dielectric apparatus applied to building components according to claim 1, further comprising a gap area.

8. The frequency tunable dielectric apparatus applied to building components according to claim 7, wherein a partial surface of the gap area and an outer surface of the structural body form a continuous surface.

9. An arrangement method of a frequency tunable dielectric apparatus applied to building components, which is used to tune a working frequency of an RF signal passing through a building component and increase transmittance and transmission bandwidth of the RF signal, the arrangement method comprising:
coupling a structural body and a frequency-tuning component to a target component by a positioning component;
wherein the structural body is formed of a dielectric material, and the frequency-tuning component is formed of at least two members matched to each other to be able to move relatively and generate displacement, which are used to adjust and maintain a spacing between the structural body and the target component in the dielectric apparatus, or between each of the structural bodies in the dielectric apparatus, so as to control the working frequency;
wherein the positioning part is configured to couple the structural body and the frequency-tuning component to the target component, and the positioning component is formed of a dielectric material in an area through which the RF signal is set to pass;
a dielectric constant value of each dielectric material ranges from more than 1 to less than 200000, the positioning component couples the structural body and the target component to form a composite structure, the composite structure correspondingly has the working frequency, and a minimum equivalent diameter of a dielectric structure corresponding to the composite structure on a projected area of a surface through which the RF signal passes on a surface of the target component is not less than one-eighth of a working wavelength corresponding to the working frequency.

10. The arrangement method of the frequency tunable dielectric apparatus applied to building components according to claim 9, further comprising disposing a gap area within the dielectric apparatus.
